(19) United States
(12) Patent Application Publication
(10) Pub. No.: US 2008/0036667 A1
(43) Pub. Date: Feb. 14, 2008

(54) Transmission line resonator loop antenna

(76) Inventor: Orest Fedan, Belmont, MA (US)

Correspondence Address: Iandiorio & Teska, 260 Bear Hill Road, Waltham, MA, 02451-1018, US

(21) Appl. No.: 11/502,191

(22) Filed: Aug. 10, 2006

(51) Int. Cl. H01Q 11/12

(52) U.S. Cl. 343/741; 343/713; 343/866

(57) ABSTRACT

A transmission line resonator loop antenna includes a transmission line resonator for receiving an input excitation signal and producing a predetermined resonant output signal which is substantially phase reversed relative to the input excitation signal; and a loop antenna having one end responsive to the phase reversed output signal and the other end responsive to a reference excitation signal for maintaining the predetermined resonance.

### FIELD OF THE INVENTION

This invention relates to a transmission line resonator loop antenna adaptable for a stolen vehicle recovery system.

### BACKGROUND OF THE INVENTION

The applicant's successful and popular vehicle recovery system sold under the trademark LoJack® includes a small electronic vehicle locating unit (VLU) with a transponder hidden within a vehicle, a private network of communication towers each with a remote transmitting unit (RTU), one or more law enforcement vehicles equipped with a vehicle tracking unit (VTU), and a network center with a database of customers who have purchased a VLU. The network center interfaces with the National Criminal Information Center. The entries of that database comprise the VIN number of the customer's vehicle and an identification code assigned to the customer's VLU.

When a LoJack® product customer reports that her vehicle has been stolen, the VIN number of the vehicle is reported to a law enforcement center for entry into a database of stolen vehicles. The network center includes software that interfaces with the database of the law enforcement center to compare the VIN number of the stolen vehicle with the database of the network center which includes VIN numbers corresponding to VLU identification codes. When there is a match between a VIN number of a stolen vehicle and a VLU identification code, as would be the case when the stolen vehicle is equipped with a VLU, and when the center has acknowledged the vehicle has been stolen, the network center communicates with the RTUs of the various communication towers (currently there are 130 nationwide) and progressively each tower transmits a message to activate the transponder of the particular VLU bearing the identification code.

The transponder of the VLU in the stolen vehicle is thus activated and begins transmitting its unique VLU identification code. The VTU of any law enforcement vehicles proximate the stolen vehicle receive this VLU transponder code and, based on signal strength and directional information, the appropriate law enforcement vehicle can take active steps to recover the stolen vehicle. See, for example, U.S. Pat. Nos. 4,177,466; 4,818,988; 4,908,609; 5,704,008; 5,917,423; 6,229,988; 6,522,698; and 6,665,613 all incorporated herein by this reference.

The antenna associated with the transponder in the VLU is desirable small, compact, high efficiency and not too susceptible to ground plane detuning as the antenna must be installed in many different makes and models of vehicles and is not assured of exact placement in any particular vehicle. There has been much work done to reduce the physical profile of antennas while still preserving reasonable radiation efficiency. Much of this work has involved antennas over a ground plane: for example, a doubly fed, air-cored, coaxial line folded back on itself (see item 16, page 20, “Small Antennas”, by K. Fujimoto, et al., Research Studies Press, 1987 herein incorporated in its entirety by this reference). In most antenna investigations, it has been assumed that the only nearby conductor was that which acted as part of the antenna (such as a ground plane). Some investigation was directed toward quantifying how much degradation can be expected from an antenna as conductive objects are brought close to it. Such investigation has been performed for various types of antennas. Although much work has been done to analyze the effects of conductors placed in close proximity to an antenna, not much has been done to try to create an antenna which is less sensitive to conductors being placed in close proximity to it.

If nearby conductors do not act as part of the antenna then they usually have a detrimental effect on the antenna. A ground plane is a nearby conductor which does act as part of the antenna. Most antennas designed to be placed on a vehicle (car, airplane, etc.) utilize the chassis of the vehicle as the ground plane. This includes slot antennas, which have a very low physical profile. However some antennas can not utilize the chassis of the vehicle as part of the antenna. As an example, covert antennas which must be hidden in random locations in a vehicle will not be able to utilize the chassis of the vehicle as part of the antenna unless they operate at short wavelengths. Even so, the number of places they can be installed is reduced if they are forced to have the restriction that they must utilize the ground plane as part of the antenna (unless they operate at very short wavelengths).

The detrimental effects on an antenna caused by the proximity of nearby conductors which are not part of the antenna can be grouped into three categories. De-tuning of the antenna: when an antenna is de-tuned, it no longer resonates at the correct frequency so radiation efficiency drops. More of the incident energy is reflected from the antenna back to the power amplifier. Field cancellation: eddy currents induced in the nearby conductors radiate opposite fields which cancel the initial fields produced by the radiating antenna. Energy absorption: eddy currents induced in the nearby conductors dissipate some of the radiated energy.

Another problem is that the above detrimental effects are intensified due to the reflective nature of resonance in the antenna system. Known antennas are resonators which establish resonance by totally reflecting the electrical waves traveling along the antenna at the antenna endpoints. These reflections are associated with a doubling of the electric field (in the case of a dipole antenna with open circuits at its endpoints), or with a doubling of the magnetic field (in the case of an antenna with a short circuits at its endpoints). The increased electric or magnetic fields are localized at the antenna endpoints and because they are localized they intensify the previously mentioned detrimental effects.

### SUMMARY OF THE INVENTION

It is therefore an object of this invention to provide a transmission line resonator loop antenna.

It is a further object of this invention to provide such a transmission line resonator loop antenna which is not easily detuned by nearby conductors.

It is a further object of this invention to provide such a transmission line resonator loop antenna in which the resonator has reduced external electric fields.

It is a further object of this invention to provide such a transmission line resonator loop antenna in which the electric field of the resonator is contained between its conductors.

It is a further object of this invention to provide such a transmission line resonator loop antenna in which there is little or no reflection since the wave travels in a circle thus eliminating the need for reflective endpoints with their associated localized magnetic and electric fields.

It is a further object of this invention to provide such a transmission line resonator loop antenna in which reduced electric fields and reduced localization of both the electric and magnetic fields results in a lower sensitivity to the presence of local detuning conductors.

The invention results from the realization that a new, unique and elegant transmission line resonator loop antenna which is more robust and less susceptible to detuning from conductors in the area can be effected with a transmission line resonator for receiving an input excitation signal and producing a predetermined resonant output signal which is substantially phase reversed relative to the input signal and a loop antenna having one end responsive to the phase reversed output signal and the other end responsive to a reference excitation signal for maintaining the predetermined resonance.

The subject invention, however, in other embodiments, need not achieve all these objectives and the claims hereof should not be limited to structures or methods capable of achieving these objectives.

This invention features a transmission line resonator loop antenna including a transmission line resonator for receiving an input excitation signal and producing a predetermined resonant output signal which is substantially phase reversed relative to the input excitation signal. There is a loop antenna having one end responsive to the phase reversed output signal and the other end responsive to a reference excitation signal for maintaining the predetermined resonance.

In a preferred embodiment the transmission line resonator may include a coaxial cable. It may include a parallel conductor transmission line or any other kind of transmission line. The parallel conductor transmission line may include ribbon conductors. The transmission line resonator may be substantially a half wavelength in length. The loop antenna may include a tuning bar interconnected between the ends of one of the conductors of the transmission line resonator. The transmission line resonator may include a coaxial cable and the tuning bar may be connected between the ends of the shield of the coaxial cable. The transmission line resonator and the loop antenna may both radiate. The transmission line resonator may be disposed in a convoluted path to reduce the size. The electric field of the transmission line resonator may be substantially contained between the conductors of the transmission line resonators.

### BRIEF DESCRIPTION OF THE DRAWINGS

Other objects, features and advantages will occur to those skilled in the art from the following description of a preferred embodiment and the accompanying drawings, in which:

FIG. 1 is a schematic diagram of a transmission line resonator loop antenna according to this invention;

FIG. 2 is a schematic diagram of a convoluted more compact arrangement of the transmission line resonator of FIG. 1; and

FIG. 3 is a schematic diagram of another construction of a transmission line resonator loop antenna according to this invention.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

The invention described by this disclosure is a new form of antenna: a Transmission Line Resonant Loop antenna. Resonance is established by looping a transmission line back on itself as in a ring type of arrangement. This avoids having to reflect the energy back on itself as in reflective resonator. In a reflective resonator, at the point of reflection there is either a high electric field (caused by high voltage in a high impedance reflection, such as at the tip of a whip antenna) or a high magnetic field (caused by high current in a low impedance reflection). This antenna, not depending on reflection, has reduced localized electric and magnetic fields.

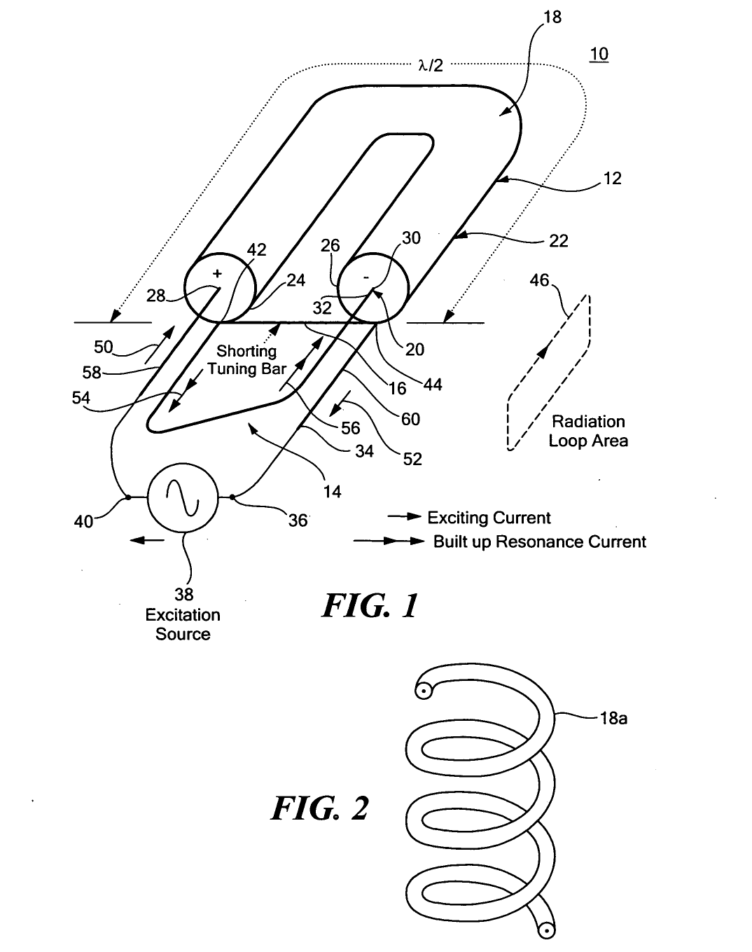

There is shown in FIG. 1 a transmission line resonator loop antenna 10 according to this invention including a transmission line resonator 12, loop antenna 14 and a shorting or tuning bar 16. In FIG. 1 the transmission line resonator 12 is formed from a coaxial cable 18 having a center conductor 20 and shield conductor 22 and the tuning bar 16 is connected between the ends 24, 26 of the shield conductor 22. The transmission line resonator may be substantially a half wavelength in length. The electric field of the transmission line resonator may be substantially contained between the conductors of the transmission line resonator.

Loop antenna 14 includes tuning bar 16 as one leg and line 60 is another leg. One end 32 of loop antenna 14 is connected to the end 30 of center conductor 20; the other end 34 is connected to the reference terminal 36 of excitation source 38. The signal terminal 40 of excitation source 38 is connected to end 28 of center conductor 20 through line 58. Tuning bar 16 connects to ends 24, 26 of shield conductor 22, at 42, 44. Its connection to shield conductor 22 defines the length of coaxial cable 18, in this case λ/2. The position of tuning bar 16 sets this length and is used to tune transmission line resonator 12. Good results for a 170 MHz resonator have been obtained with an excitation of approximately 10 volts and 200 ma. The radiation loop area 46 is defined by loop 14. While transmission line resonator 12 provides the resonator function it operates virtually independent of the presence, proximity or absence of a ground plane or conductor. This is so because the shield conductor 22 acts as the self contained ground plane which has a predetermined and fixed effect on the transmission line resonator. This greatly reduces the effect of any conductors in the area.

In operation, excitation source 38 provides an input excitation signal 50 at end 28 and a reference excitation signal 52 at end 34, which changes polarity (direction) each half cycle. Correspondingly, the increased resonant currents 54, 56 flow in opposite directions to currents 50, 52, respectively, changing direction each half cycle.

The λ/2 transmission line resonates to produce high impedance voltages shown as + at 28 and − at 30 in FIG. 1. The voltage at 30 excites the loop antenna resonant currents 54 and 56. Currents 54 and 56 magnetically couple to lines 58 and 60, respectively, reducing the impedance level at the terminals of the excitation source 36 and 40, to the characteristic impedance of the excitation source, thus providing maximum power transfer.

The preferred orientation to nearby conductors (such as the chassis of a vehicle) is such that the shorting bar side of the antenna faces the nearby conductors. The voltages at the ends of the center conductor 28, 30 are isolated from nearby conductors by the presence of shield conductor 22, resulting in less detuning. Another advantage of coaxial cable 18 is that it can be configured in an indirect, convoluted path such as a coil or helix 18a, FIG. 2, for example, which reduces the physical size of transmission line resonator 12 while only moderately decreasing radiation efficiency.

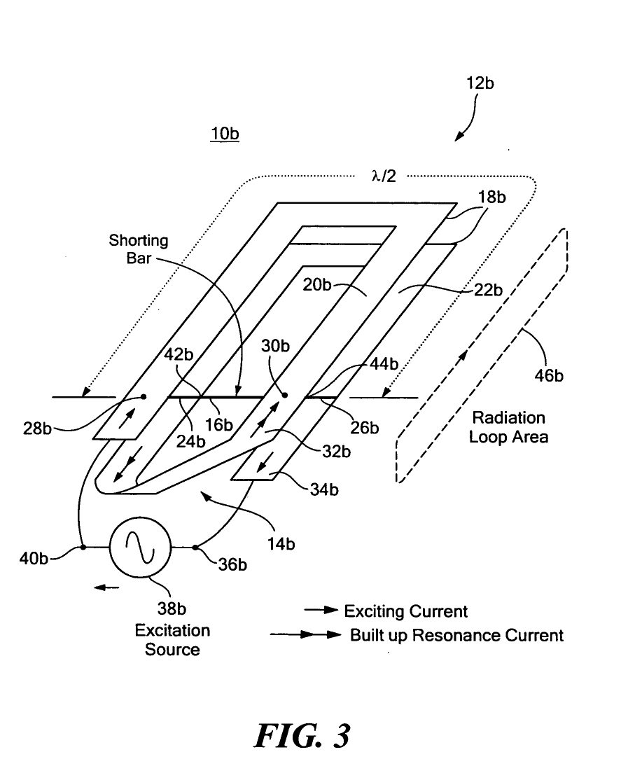

This invention is not limited to any particular construction. For example, the transmission line resonator 12b, FIG. 3, may be implemented with a parallel conductor transmission line 18b having ribbon conductors 20b, 22b. Here, the self-contained ground plane effect is slightly less due to the open sides which allow some fringing of the fields but it is still very much relatively independent of detuning from nearby conductors and the transmission line resonator 12b itself may contribute to antenna radiation as indicated by the enlarged radiation loop area 46b. This construction, too, can be made more compact by configuring transmission line resonator 18b in a convoluted path, however, such compacting is limited by the fringing of the fields along the open sides.

Comparing FIGS. 1 and 3, the construction of FIG. 1 has reduced radiation efficiency because the radiation loop area is reduced but the reduction in efficiency is not proportional to the reduction in the radiation loop area. Most of the radiation current is localized in the loop 14 outside of the λ/2 length of transmission line; inside the λ/2 length of transmission line, the current redistributes according to the known transmission line equation.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A transmission line resonator loop antenna comprising:
a transmission line resonator for receiving an input excitation signal and producing a predetermined resonant output signal which is substantially phase reversed relative to said input excitation signal; and
a loop antenna having one end responsive to said phase reversed output signal and the other end responsive to a reference excitation signal for maintaining said predetermined resonance.

2. The transmission line resonator loop antenna of claim 1 in which said transmission line resonator includes a coaxial cable.

3. The transmission line resonator loop antenna of claim 1 in which said transmission line resonator includes a parallel conductor transmission line.

4. The transmission line resonator loop antenna of claim 3 in which said parallel conductor transmission line includes ribbon conductors.

5. The transmission line resonator loop antenna of claim 1 in which said transmission line resonator is substantially a half wavelength in length.

6. The transmission line resonator loop antenna of claim 1 in which said loop antenna includes a tuning bar interconnected between the ends of one of the conductors of said transmission line resonator.

7. The transmission line resonator loop antenna of claim 6 in which said transmission line resonator includes a coaxial cable and said tuning bar is connected between the ends of the shield of the coaxial cable.

8. The transmission line resonator loop antenna of claim 1 in which said transmission line resonator and said loop antenna both radiate.

9. The transmission line resonator loop antenna of claim 1 in which said transmission line resonator is disposed in a convoluted path to reduce the size.

10. The transmission line resonator loop antenna of claim 1 in which the electric field of said transmission line resonator is substantially contained between the conductors of said transmission line resonator.
